(19) United States
(12) Patent Application Publication
(10) Pub. No.: US 2025/0006029 A1
(43) Pub. Date: Jan. 2, 2025

(54) ELECTRONIC ARTICLE SURVEILLANCE (EAS) USING PIEZOELECTRONIC COMPONENTS EMBEDDED IN SURVEILLED ARTICLES

(71) Applicant: Sensormatic Electronics, LLC, Boca Raton, FL (US)

(72) Inventor: Adam S. BERGMAN, Boca Raton, FL (US)

(21) Appl. No.: 18/699,063

(22) PCT Filed: Oct. 5, 2022
(86) PCT No.: PCT/US2022/077608

§ 371 Date: Apr. 5, 2024

Related U.S. Application Data
(60) Provisional application No. 63/253,737, filed on Oct. 8, 2021.

(51) Int. Cl. G08B 13/24; G06K 19/07

(52) U.S. Cl. CPC G08B 13/2422; G06K 19/0711; G06K 19/0728; G08B 13/2445

(57) ABSTRACT

An article to be surveilled includes an article body and an electronic article surveillance (EAS) tag. The EAS tag is attached to, preferably integrated into the article body. The tag includes a power source, a processing device in electrical communication with the a power source, and at least one piezoelectric element in electrical communication with the processing device. The processing device is operative under certain conditions to use power from the power source to generate a signal causing the at least one piezoelectric element to emit ultrasound energy in a pattern based on the signal. In some examples, the tag, transmitting an ultrasound signal emitted by the piezoelectric element is detected by a reader of the EAS system. The EAS system determines whether the detected signal meets an alarm condition; and upon such determining, indicates, an alarm.

### CROSS REFERENCE TO RELATED APPLICATIONS

The present disclosure claims the benefit of U.S. Provisional Patent Application No. 63/253,737, titled “ELECTRONIC ARTICLE SURVEILLANCE (EAS) USING PIEZOELECTRIC COMPONENTS EMBEDDED IN SURVEILLED ARTICLES,” filed Oct. 8, 2021, the entirety of which is incorporated by reference hereon.

### TECHNICAL FIELD

The present disclosure relates generally to electronic article surveillance (“EAS”), and more particularly, to electronic article surveillance (EAS) using piezoelectric components embedded in surveilled articles.

### BRIEF DESCRIPTION OF THE DRAWINGS

FIG. 1 is an illustration of an illustrative architecture for a system.

FIG. 2 is an illustration of an illustrative architecture for a tag.

FIG. 3 is an illustration of an illustrative architecture for a tag reader.

FIG. 4 is an illustration of an illustrative architecture for a server.

FIG. 5 is a flow chart of a method of electronic article surveillance, in accordance with examples of the technology disclosed herein.

### DETAILED DESCRIPTION

EAS systems are used to control inventory and to prevent or deter theft or unauthorized removal of articles from a controlled area. Typical EAS systems establish an “interrogation zone” that defines a surveillance zone (for example, entrances and/or exits in retail stores) encompassing the controlled area. The articles to be protected are tagged with an EAS security tag. Conventional tags are designed to interact with the field in the interrogation zone, e.g., established by an EAS portal. The EAS portal includes one or more EAS readers (e.g., transmitter/receiver, antennas). The presence of a tag in the interrogation zone is detected by the system and appropriate action is taken. In most cases, the appropriate action includes the activation of an alarm.

In the retail industry, it is common to “source tag” articles with RFID tags, either at the time of packaging/manufacture, or at some other point in the supply chain. At the same time, EAS technology and devices have proven critical to the reduction of theft and so called “shrink.” Since many articles arrive at the retailer with tags, RFID tags can be used also to provide EAS functionality in addition to their intended function of providing capabilities such as inventory control, shelf reading, non-line of sight reading, etc. In some implementations, an RFID tag can be used to simulate EAS functionality by sending special codes when a reader interrogates the RFID tag. This arrangement advantageously eliminates the need for a separate EAS component, such as an acousto-magnetic (“AM”) component, within the tag, or a separate EAS tag. Various schemes can be used to enable the use of RFID tags to simulate EAS functionality. In some such systems, the RFID tag indicates in some way that the item to which the tag is attached has been purchased at point of sale (“POS”). If the RFID tag is a detachable tag, the RFID tag can be simply detached at the POS. In such a system, the RFID readers at the exit would trigger an alarm if any tags are detected. In some such systems, data is written to the RFID chip at the POS to confirm the item was purchased. One common method is encoding a bit-flip at the POS, with the changed bit indicating that the item is authorized for removal. Other systems may read a unique ID from the tag, and store the unique ID in the enterprise system when the tagged item is purchased, so that the purchase can be verified by RFID readers as the tag exits the premises. If the purchase of the item cannot be verified based on tag data when the tag passes out of the store, an alarm can be triggered.

Regardless of the functionality developed for tags, whether RFID, AM, or a combination, such tags typically embody a device in addition to the item that the tag is meant to track or protect. Such tags may interfere with a potential customer interacting with the item. Such tag assemblies may come in separate parts (e.g., tag body and separate tag pin/tack) that need to be attached to the item, and can be lost, misplaced, or mismatched. Such tags may require detachment devices, and some of those detachment devices may be readily reproducible.

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Examples of the technology disclosed herein include methods, systems, and tags of electronic article surveillance (EAS). In some examples, an article to be surveilled includes an article body and an electronic article surveillance (EAS) tag. The EAS tag is attached to, preferably integrated into, the article body. The tag includes a power source, a processing device in electrical communication with the a power source, and at least one piezoelectric element in electrical communication with the processing device. The processing device is operative under certain conditions to use power from the power source to generate a signal causing the at least one piezoelectric element to emit ultrasound energy in a pattern based on the signal. In some examples, the tag, transmitting an ultrasound signal emitted by the piezoelectric element is detected by a reader of the EAS system. The EAS system determines whether the detected signal meets an alarm condition; and upon such determining, indicates, an alarm.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present solution may be embodied in other specific forms without departing from its spirit or essential characteristics. The described embodiments are to be considered in all respects only as illustrative and not restrictive. The scope of the present solution is, therefore, indicated by the appended claims rather than by this detailed description. All changes that come within the meaning and range of equivalency of the claims are to be embraced within their scope.

Reference throughout this specification to features, advantages, or similar language does not imply that all of the features and advantages that may be realized with the present solution should be or are in any single embodiment of the present solution. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages, and characteristics of the present solution may be combined in any suitable manner in one or more embodiments. One skilled in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

Reference throughout this specification to “one embodiment,” “an embodiment,” or similar language means that a particular feature, structure, or characteristic described in connection with the indicated embodiment is included in at least one embodiment of the present solution. Thus, the phrases “in one embodiment”, “in an embodiment,” and similar language throughout this specification may, but do not necessarily, all refer to the same embodiment.

As used in this document, the singular form “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to.”

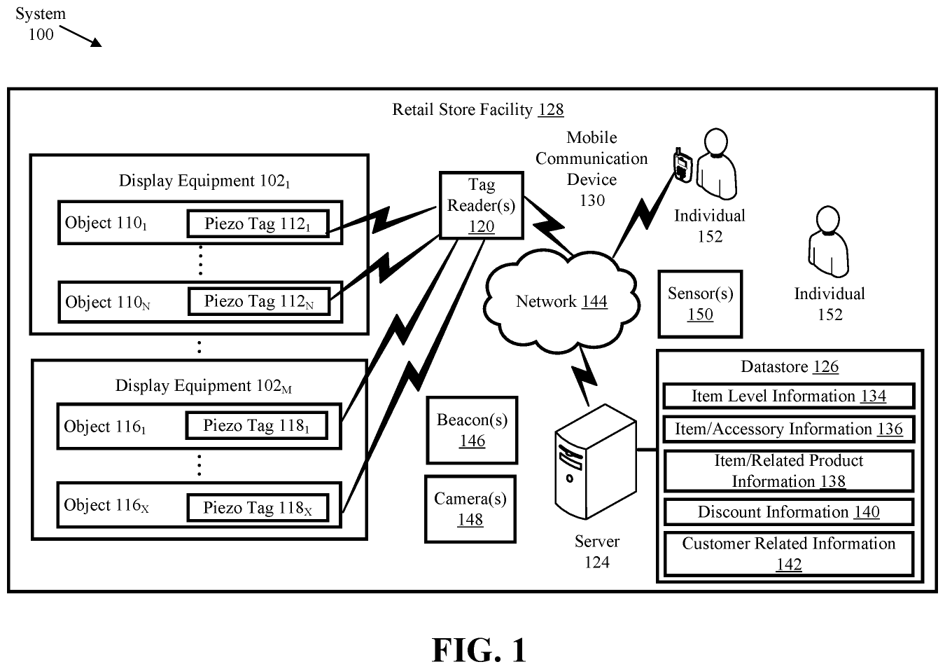

Referring now to FIG. 1, there is provided a schematic illustration of an illustrative system 100 that is useful for understanding the present technology. The present technology is described herein in relation to a retail store environment. The present solution is not limited in this regard, and can be used in other environments. For example, the present technology can be used in distribution centers, factories and other commercial environments. Notably, the present technology can be employed in any environment in which objects and/or items need to be located and/or tracked.

The system 100 is generally configured to facilitate (a) inventory counts and surveillance of objects and/or items located within a facility, and (b) improved customer experiences. As shown in FIG. 1, system 100 comprises a Retail Store Facility (“RSF”) 128 in which display equipment 102₁, . . . 102_{M} is disposed. The display equipment is provided for displaying objects (also referred to as “items” or “articles”) 110₁-110_{N}, 116₁-116_{X} to customers of the retail store. The display equipment can include, but is not limited to, shelves, article display cabinets, promotional displays, fixtures, and/or equipment securing areas of the RSF 128. The RSF can also include emergency equipment (not shown), checkout counters. Emergency equipment, checkout counters, video cameras, and people counters, are well known in the art, and therefore will not be described herein. At least one tag reader 120 is provided to surveil the objects 110₁-110_{N}, 116₁-116_{X} within the RSF 128.

Piezoelectric tags 112₁-112_{N}, 118₁-118_{X} are respectively attached, coupled to, or integrated into the objects 110₁-110_{N}, 116₁-116_{X}. Traditionally, such coupling is achieved via an adhesive (e.g., glue, tape, or sticker), a mechanical coupler (e.g., straps, clamps, snaps, etc.), a weld, chemical bond, or other means. Traditional tags can alternatively or additionally comprise dual-technology tags that have both EAS and RFID capabilities as described herein.

Piezoelectric tags 112₁-112_{N}, 118₁-118_{X}, described in more detail below, offer the option to be integrated into the objects 110₁-110_{N}, 116₁-116_{X}, and can be (but are not necessarily) hidden. For example, piezoelectric tags 112₁-112_{N}, 118₁-118_{X} can be woven into the fabric of an article of clothing. Piezoelectric tags 112₁-112_{N}, 118₁-118_{X} can be used for loss prevention, inventory, and access control. Piezoelectric tags 112₁-112_{N}, 118₁-118_{X}, can present a smaller form factor than conventional tags. And with little or no electromagnetic radiation of the interrogation zone required, piezoelectric tags 112₁-112_{N}, 118₁-118_{X} can address concerns about the levels of electromagnetic radiation to which customers and personnel may be exposed.

Notably, at least one tag reader 120 is placed at a known location within the RSF 128, for example, at an exit/entrance. By correlating the tag reader's tag reads and the tag reader's known location within the RSF 128, it is possible to determine the general location of objects 110₁, . . . , 110_{N}, 116₁, . . . , 116_{X} within the RSF 128 based on readings of piezoelectric tags 112₁-112_{N}, 118₁-118_{X}. The tag reader's known coverage area also facilitates object location determinations. For example, the field of view of an ultrasonic microphone can be used to locate a responding piezoelectric tag 112₁-112_{N}, 118₁-118_{X}. Accordingly, tag read information and tag reader location information can be stored in a datastore 126. This information can be stored in the datastore 126 using a server 124 and network 144 (e.g., an Intranet and/or Internet).

System 100 also includes a Mobile Communication Device (“MCD”) 130. MCD 130 includes, but is not limited to, a cell phone, a smart phone, a table computer, a personal digital assistant, and/or a wearable device (e.g., a smart watch). Each of the listed devices is well known in the art, and therefore will not be described herein. In accordance with some examples, the MCD 130 has a software application installed thereon that is operative to: facilitate the provision of various information 134-142 to the individual 152: facilitate a purchase transaction; and/or facilitate the deactivation of the tags 112₁-112_{N}, 118₁-118_{X}.

The MCD 130 is generally configured to provide a visual and/or auditory output of item level information 134, accessory information 136, related product information 138, discount information 140 and/or customer related information 142. The item level information includes, but is not limited to, an item description, item nutritional information, a promotional message, an item regular price, an item sale price, a currency symbol, and/or a source of the item.

The discount information can include, but is not limited to, a discount price for a product based on a loyalty level or other criteria. The customer related information includes, but is not limited to, customer account numbers, customer identifiers, usernames, passwords, payment information, loyalty levels, historical purchase information, and/or activity trends.

The item level information, accessory information, related product information and/or discount in-formation can be output in a format selected from a plurality of formats based on a geographic location of the item, a location of the MCD, a date, and/or an item pricing status (i.e., whether the item is on sale). In a display context, the format is defined by a font parameter, a color parameter, a brightness parameter, and/or a display blinking parameter. In an auditory context, the format is defined by a volume parameter, a voice tone parameter, and/or a male/female voice selected parameter.

An MCD 130 with a microphone having an pickup response in the ultrasonic range can also be configured to read tags 112, 118. Information obtained from the tag reads may be communicated from the MCD 130 to the server 124 via network 144. Similarly, the stored information 134-142 is provided from the server 124 to the MCD 130 via network 144. The network 144 includes an Intranet and/or the Internet.

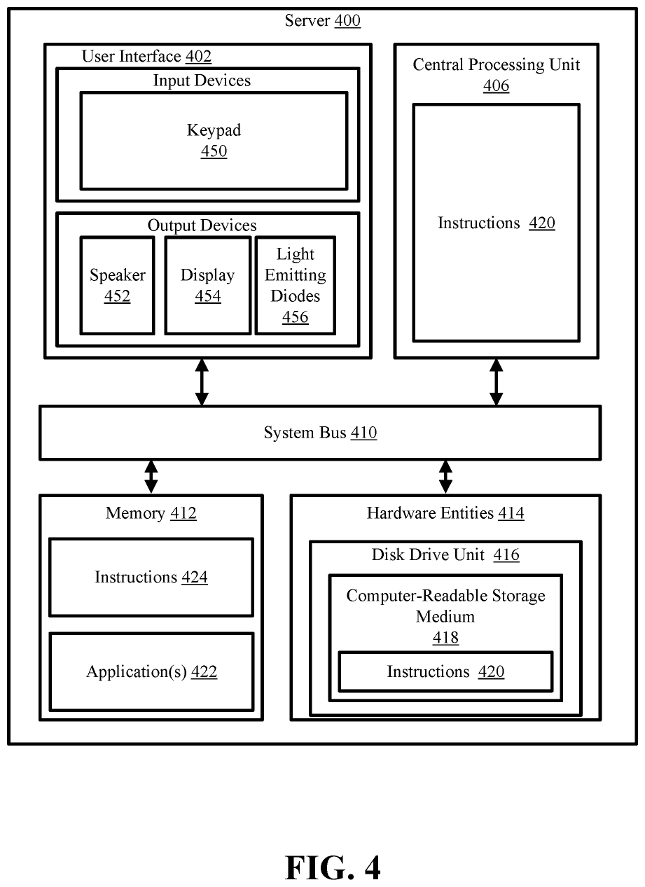

Server 124 can be local to the facility 128 as shown in FIG. 1 or remote from the facility 128. Server 124 will be described in more detail below in relation to FIG. 4. Still, it should be understood that server 124 is configured to: write data to and read data from datastore 126, tags 112₁-112_{N}, 118₁-118_{X}, and/or MCD 130; perform language and currency conversion operations using item level information and/or accessory information obtained from the datastore, tags, and/or MCD: perform data analytics based on inventory information, tag read information, MCD tacking information, and/or information 134-142: perform image processing using images captured by camera(s) 148; and/or determine locations of tags and/or MCDs in the RSF 128 using tag reader 120 or other devices having known locations and/or tag response senor patterns.

In some examples, one or more beacons 146 transmitting an RF signal (second RF signal that is non-RFID) other than the RFID interrogation signal are placed to cover a zone of interest also covered by a tag reader 120 placed to cover an RFID interrogation zone, e.g., at a portal of the retail facility 128. In some examples, the system 100 can detect and derive any number of relevant indicators based on second RF signal. The tag 112/118 response to the second RF signal is analyzed and compared to data collected by the RFID signal response that occurred concurrently with the tag's passage through the portal.

The server 124 facilitates updates to the information 134-142 output from the MCD 130. Such information updating can be performed periodically, in response to instructions received from an associate (e.g., a retail store employee 132), in response to a detected change in the item level, accessory and/or related product information, in response to a detection that an individual is in proximity to an RFID tag, and/or in response to any motion or movement of the RFID tag. For example, if a certain product is placed on sale, then the sale price for that product is transmitted to MCD 130 via network 144 and/or the tag. The sale price is then output from the MCD 130. The present solution is not limited to the particulars of this example.

Although a single MCD 130 and/or a single server 124 is (are) shown in FIG. 1, the present solution is not limited in this regard. It is contemplated that more than one computing device can be implemented. In addition, the present solution is not limited to the illustrative system architecture de-scribed in relation to FIG. 1.

During operation of system 100, the content displayed on the display screen of the MCD 130 is dynamically controlled based upon various tag or item related information and/or customer related information (e.g., mobile device identifier, mobile device location in RSF 128, and/or customer loyalty level). Tag or item level information includes, but is not limited to, first information indicating that an RFID tag is in motion or that an object is being handled by an individual 152, second information indicating a current location of the RFID tag and/or the MCD 130, third information indicating an accessory or related product of the object to which the moving tag is coupled, and/or fourth information indicating the relative locations of the accessory and the moving tag and/or the relative locations of the related product and the moving tag. The first, second and fourth information can be derived based on sensor data generated by sensors local to the tag. Accordingly, the tags 112₁-112_{N}, 118₁-118_{X} may include one or more sensors to detect their current locations, detect any individual in proximity thereto, and/or detect any motion or movement thereof. The sensors include, but are not limited to, an Inertial Measurement Unit (“IMU”), a vibration sensor, a light sensor, an accelerometer, a gyroscope, a proximity sensor, a microphone, and/or a beacon communication device. The third information can be stored local to the tag(s) or in a remote datastore 126 as information 136, 138.

In some scenarios, the MCD 130 facilitates the server's 124 (a) detection of when the individual 152 enters the RSF 128, (b) tracking of the individual's movement through the RSF, (c) detection of when the individual is in proximity to an object to which an RFID tag is coupled. (d) determination that an RFID tag is being handled or moved by the individual based on a time stamped pattern of MCD movement and a timestamped pattern of RFID tag movement, and/or (e) determination of an association of moving RFID tags and the individual.

When a detection is made that an tag is being moved, the server 124 can, in some scenarios, obtain customer related information (such as a loyalty level) 142 associated with the individual 152. This information can be obtained from the individual's MCD 130 and/or the datastore 126. The customer related information 142 is then used to retrieve discount information 140 for the object to which the tag is coupled. The retrieved discount information is then communicated from the server 124 to the individual's MCD 130. The individual's MCD 130 can output the discount information in a visual format and/or an auditory format. Other information may also be communicated from the server 124 to the individual's MCD 130. The other information includes, but is not limited to, item level information, accessory information, and/or related product information.

In those or other scenarios, a sensor embedded in the tag detects when an individual is handling the object to which the tag is coupled. When such a detection is made, the tag retrieves the object's unique identifier from its local memory, and communicates the same to the tag reader 120. The tag reader 120 then passes the information to the server 124. The server 124 uses the object's unique identifier and the item/accessory relationship in-formation (e.g., table) 136 to determine if there are any accessories associated therewith. If no accessories exist for the object, the server 124 uses the item level information 134 to determine one or more characteristics of the object. For example, the object includes a product of a specific brand. The server 124 then uses the item/related product information (e.g., table) 138 to identify: other products of the same type with the same characteristics; and/or other products that are typically used in conjunction with the object. Related product information for the identified related products is then retrieved and provided to the MCD 130. The MCD 130 can output the related product information in a visual format and/or an auditory format. The individual 152 can perform user-software interactions with the MCD 130 to obtain further information obtain the related product of interest. The present solution is not limited to the particulars of this scenario.

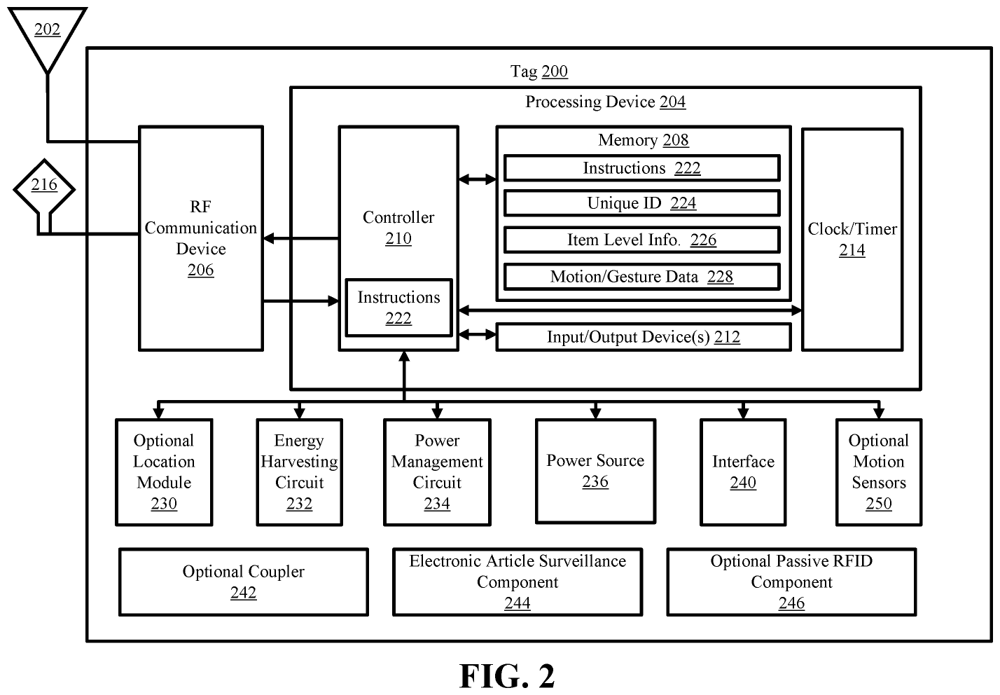

Referring now to FIG. 2, there is an illustration of an illustrative architecture for a tag 200. Tags 112₁, . . . , 112_{N}, 118₁ . . . . 118_{X} can be the same as or similar to tag 200. As such, the discussion of tag 200 is sufficient for understanding the tags 112₁, . . . , 112_{N}, 118₁, . . . , 118_{X} of FIG. 1. Tag 200 can be generally configured to perform operations to (a) minimize power usage so as to extend a power source's life (e.g., a piezoelectric component, a battery, or a capacitor), (b) minimize collisions with other tags so that the tag of interest can be seen at given times, (c) optimize useful information within an inventory system (e.g., communicate useful change information to a tag reader), and/or (d) optimize local feature functions.

The tag 200 can include more or less components than that shown in FIG. 2. However, the components shown are sufficient to disclose an illustrative embodiments implementing the present solution. Some or all of the components of the tag 200 can be implemented in hardware, software and/or a combination of hardware and software. The hardware includes, but is not limited to, one or more electronic circuits. The electronic circuit(s) may comprise passive components (e.g., capacitors and resistors) and active components (e.g., processors) arranged and/or programmed to implement the methods disclosed herein.

The hardware architecture of FIG. 2 represents a representative tag 200 configured to facilitate improved inventory management/surveillance and customer experience. In this regard, the tag 200 can be configured for allowing data to be exchanged with an external device (e.g., tag reader 120 of FIG. 1, a beacon 146 of FIG. 1, a properly equipped MCD 130 of FIG. 1, and/or server 124 of FIG. 1) via communication technology (e.g., sound including ultrasound, light, or electromagnetic). Wireless electromagnetic communication technology can include, but is not limited to, a Radio Frequency Identification (“RFID”) technology, a Near Field Communication (“NFC”) technology, and/or a Short Range Communication (“SRC”) technology. For example, one or more of the following wireless communication technologies (is) are employed: Radio Frequency (“RF”) communication technology: Bluetooth technology (including Bluetooth Low Energy (LE)); WiFi technology: beacon technology; and/or LiFi technology. Each of the listed wireless communication technologies is well known in the art, and therefore will not be described in detail herein. Any known or to be known wireless communication technology or other wireless communication technology can be used herein without limitation. The above wireless technologies are optional in some tags 200 of the present technology. Both a power source, and a piezoelectric EAS component are included in each example of the present technology.

The components 206-214 shown in FIG. 2 may be collectively referred to herein as a processing device 204, and include a memory 208 and a clock/timer 214. Memory 208 may be a volatile memory and/or a non-volatile memory. For example, the memory 208 can include, but is not limited to, Random Access Memory (“RAM”), Dynamic RAM (“DRAM”), Static RAM (“SRAM”), Read Only Memory (“ROM”), and flash memory. The memory 208 may also comprise unsecure memory and/or secure memory. In some examples, processing device 204 is a printed circuit without instructions or a controller that is arranged to output a predetermined signal to RF communication device 206 and/or EAS component 244.

In some scenarios, the processing device 204 can include a Software Defined Radio (“SDR”). SDRs are well known in the art, and therefore will not be described in detail herein. However, it should be noted that the SDR can be programmatically assigned any communication protocol that is chosen by a user (e.g., RFID, WiFi, LiFi, Bluetooth, BLE, Nest, ZWave, Zigbee, etc.). The communication protocols are part of the device's firmware and reside in memory 208. Notably, the communication protocols can be downloaded to the device at any given time. The initial/default role (being an RFID, WiFi, LiFi, etc. tag) can be assigned at the deployment thereof. If the user desires to use another protocol later, the user can remotely change the communication protocol of the deployed tag 200. The update of the firmware, in case of issues, can also be performed remotely.

As shown in FIG. 2, the processing device 204 can include at least one antenna 202, 216 for allowing data to be exchanged with the external device via a wireless communication technology (e.g., an RFID technology, an NFC technology, a SRC technology, and/or a beacon technology). The antenna 202, 216 is configured to receive signals from the external device and/or transmit signals generated by the device 204. The antenna 202, 216 can comprise a near-field or far-field antenna. The antennas include, but are not limited to, a chip antenna or a loop antenna.

The tag 200 also can include a communication device (e.g., a transceiver or transmitter) 206. Communication devices (e.g., transceivers or transmitters) are well known in the art, and therefore will not be described herein. However, it should be understood that the communication device 206 generates and transmits signals (e.g., RF carrier signals) to external devices, as well as receives signals (e.g., RF signals) transmitted from external devices. In this way, the tag 200 facilitates the registration, identification, location and/or tracking of an item (e.g., object 110 or 116 of FIG. 1) to which the tag 200 is coupled.

The processing device 204 can be configured so that it: communicates (transmits and receives) in accordance with a time slot communication scheme; and selectively enables/disables/bypasses the communication device (e.g., transceiver) or at least one communications operation based on output of a motion sensor 250. In some scenarios, the processing device 204 selects: one or more time slots from a plurality of time slots based on the tag's unique identifier 224 (e.g., an Electronic Product Code (“EPC”)); and/or determines a Window Of Time (“WOT”) during which the communication device (e.g., transceiver) 206 is to be turned on or at least one communications operation is be enabled subsequent to when motion is detected by the motion sensor 250. The WOT can be determined based on environmental conditions (e.g., humidity, temperature, time of day, relative distance to a location device (e.g., beacon or location tag), etc.) and/or system conditions (e.g., amount of traffic, interference occurrences, etc.). In this regard, the tag 200 can include additional sensors not shown in FIG. 2.

The processing device 204 also can facilitate the automatic and dynamic modification of item level information 226 that is being or is to be output from the tag 200 in response to certain trigger events. The trigger events can include, but are not limited to, the tag's arrival at a particular facility (e.g., RSF 128 of FIG. 1), the tag's arrival in a particular country or geographic region, a date occurrence, a time occurrence, a price change, and/or the reception of user instructions.

Item level information 226 and a unique identifier (“ID”) 224 for the tag 200 can be stored in memory 208 of the processing device 204 and/or communicated to other external devices (e.g., tag reader 120 of FIG. 1, beacon 146 of FIG. 1, MCD 130 of FIG. 1, and/or server 124 of FIG. 1) via communication device (e.g., transceiver) 206 and/or interface 240 (e.g., an Internet Protocol or cellular network interface). For example, the processing device 204 can communicate information specifying a timestamp, a unique identifier for an item, item description, item price, a currency symbol and/or location information to an external device. The external device (e.g., server or MCD) can then store the information in a database (e.g., database 126 of FIG. 1) and/or use the information for various purposes.

The processing device 204 can also include a controller 210 (e.g., a CPU) and in-put/output devices 212. The controller 210 can execute instructions 222 implementing methods for facilitating inventory counts and management. In this regard, the controller 210 includes a processor (or logic circuitry that responds to instructions) and the memory 208 includes a computer-readable storage medium on which is stored one or more sets of instructions 222 (e.g., software code) configured to implement one or more of the methodologies, procedures, or functions described herein. The instructions 222 also can reside, completely or at least partially, with-in the controller 210 during execution thereof by the tag 200. The memory 208 and the controller 210 can also constitute non-transitory machine-readable media. The term “machine-readable media,” as used here, refers to a single medium or multiple media (e.g., a centralized or distributed database, and/or associated caches and servers) that store the one or more sets of instructions 222. The term “machine-readable media,” as used here, also refers to any medium that is capable of storing, encoding, or carrying a set of instructions 222 for execution by the tag 200 and that cause the tag 200 to perform any one or more of the methodologies of the present disclosure.

The input/output devices can include, but are not limited to, a display (e.g., an E Ink display, an LCD display and/or an active matrix display), a speaker, a keypad, and/or light emitting diodes. The display can be used to present item level information in a textual format and/or graphical format. Similarly, the speaker can be used to output item level information in an auditory format. The speaker and/or light emitting diodes can be used to output alerts for drawing a person's attention to the tag 200 (e.g., when motion thereof has been detected) and/or for notifying the person of a particular pricing status (e.g., on sale status) of the item to which the tag is coupled.

The clock/timer 214 can be configured to determine a date, a time, and/or an expiration of a pre-defined period of time. Technique for determining these listed items are well known in the art, and therefore will not be described herein. Any known or to be known technique for determining these listed items can be used herein without limitation.

The tag 200 also can include an optional location module 230. The location module 230 can generally be configured to determine the geographic location of the tag at any given time. For example, in some scenarios, the location module 230 employs Global Positioning System (“GPS”) technology and/or Internet based local time acquisition technology. The present solution is not limited to the particulars of this example. Any known or to be known technique for determining a geographic lo-cation can be used herein without limitation including relative positioning within a facility or structure.

The optional coupler 242 can be provided to securely or removably couple the tag 200 to an item (e.g., object 110 or 116 of FIG. 1). The coupler 242 can include, but is not limited to, a mechanical coupling means (e.g., a strap, clip, clamp, snap) and/or adhesive (e.g., glue or sticker). The coupler 242 is optional since the coupling can be achieved via a weld and/or chemical bond. In examples of the present technology, the tag 200 is integrated into the item to be surveilled.

The tag 200 can also include a power source 236, an Electronic Article Surveillance (“EAS”) component 244, and/or a passive/active/semi-passive RFID component 246. The power source 236 can include, but is not limited to, a battery (including a rechargeable battery) and/or a capacitor.

As shown in FIG. 2, the tag 200 further can include an energy harvesting circuit 232 and a power management circuit 234 for ensuring continuous operation of the tag 200 without the need to change the rechargeable power source (e.g., a battery). In some scenarios, the energy harvesting circuit 232 is configured to harvest energy from one or more sources (e.g., heat, light, vibration, magnetic field, movement and/or RF energy) and to generate a relatively low amount of output power from the harvested energy. By employing multiple sources for harvesting, the device can continue to charge despite the depletion of a source of energy. In some examples, the power management function can be performed in, or under the control of, processing device 204. In some examples, the energy harvesting circuit includes a second piezoelectric element operative to output electrical energy upon the application of force to the second piezoelectric element. In such examples, the power source comprises an energy storage device; and the EAS tag 200 is operative, upon the application of force to the second piezoelectric element, to charge the energy storage device.

As noted above, the tag 200 may also include a motion sensor 250. Motion sensors are well known in the art, and therefore will not be described herein. Any known or to be known motion sensor can be used herein without limitation. For example, the motion sensor 250 includes, but is not limited to, a vibration sensor, an accelerometer, a gyroscope, a linear motion sensor, a Passive Infrared (“PIR”) sensor, a tilt sensor, and/or a rotation sensor.

The motion sensor 250 can be communicatively coupled to the controller 210 such that it can notify the controller 210 when tag motion is detected. The motion sensor 250 can also communicate sensor data to the controller 210. The sensor data can be processed by the controller 210 to determine whether or not the motion is of a type for triggering enablement of the communication device (e.g., transceiver) 206 or at least one communications operation. For example, the sensor data can be compared to stored motion/gesture data 228 to determine if a match exists there-between. More specifically, a motion/gesture pattern specified by the sensor data can be compared to a plurality of motion/gesture patterns specified by the stored motion/gesture data 228. The plurality of motion/gesture patterns can include, but are not limited to, a motion pattern for walking, a motion pattern for running, a motion pattern for vehicle transport, a motion pattern for vibration caused by equipment or machinery in proximity to the tag (e.g., an air conditioner or fan), a gesture for requesting assistance, a gesture for obtaining additional product information, and/or a gesture for product purchase. The type of movement (e.g., vibration or being carried) is then determined based on which stored motion/gesture data matches the sensor data. This feature of the present technology can allows the tag 200 to selectively enable the communication device (e.g., transceiver) or at least one communications operation only when the tag's location within a facility is actually being changed (e.g., and not when a fan is causing the tag to simply vibrate).

In some scenarios, the tag 200 can be also configured to enter a sleep state in which at least the motion sensor triggering of communication operations is disabled. This is desirable, for example, in scenarios when the tag 200 is being shipped or transported from a distributor to a customer. In those or other scenarios, the tag 200 can be further configured to enter the sleep state in response to its continuous detection of motion for a given period of time. The tag can be transitioned from its sleep state in response to expiration of a defined time period, the tag's reception of a control signal from an external device, and/or the tag's detection of no motion for a period of time.

The power management circuit 234 is generally configured to control the supply of power to components of the tag 200. In the event all of the storage and harvesting resources deplete to a point where the tag 200 is about to enter a shutdown/brownout state, the power management circuit 234 can cause an alert to be sent from the tag 200 to a remote device (e.g., tag reader 120 or server 124 of FIG. 1). In response to the alert, the remote device can inform an associate (e.g., a store employee 132 of FIG. 1) so that(s)he can investigate why the tag 200 is not recharging and/or holding charge.

The power management circuit 234 is also capable of redirecting an energy source to the tag's 200 electronics based on the energy source's status. For example, if harvested energy is sufficient to run the tag's 200 function, the power management circuit 234 confirms that all of the tag's 200 storage sources are fully charged such that the tag's 200 electronic components can be run directly from the harvested energy. This can ensure that the tag 200 has stored energy in case harvesting source(s) disappear or lesser energy is harvested for reasons such as drop in RF, light or vibration power levels. If a sudden drop in any of the energy sources is detected, the power management circuit 234 can cause an alert condition to be sent from the tag 200 to the remote device (e.g., tag reader 120 or server 124 of FIG. 1). At this point, an investigation may be required as to what caused this alarm. Accordingly, the remote device can inform the associate (e.g., a store employee 132 of FIG. 1) so that(s)he can investigate the issue. It may be that other merchandise are obscuring the harvesting source or the item is being stolen.

The present solution is not limited to that shown in FIG. 2. The tag 200 can have any architecture provided that it can perform the functions and operations described herein. For example, all of the components shown in FIG. 2 can comprise a single device (e.g., an Integrated Circuit (“IC”)). Alternatively, some of the components can comprise a first tag element (e.g., a Commercial Off The Shelf (“COTS”) tag) while the remaining components comprise a second tag element communicatively coupled to the first tag element. The second tag element can provide auxiliary functions (e.g., motion sensing, etc.) to the first tag element. The second tag element may also control operational states of the first tag element. For example, the second tag element can selectively (a) enable and disable one or more features/operations of the first tag element (e.g., transceiver operations), (b) couple or decouple an antenna to and from the first tag element. (c) by-pass at least one communications device or operation, and/or (d) cause an operational state of the first tag element to be changed (e.g., cause transitioning the first tag element between a power save mode and non-power save mode). In some scenarios, the operational state change can be achieved by changing the binary value of at least one state bit (e.g., from 0 to 1, or vice versa) for causing certain communication control operations to be performed by the tag 200. Additionally or alternatively, a switch can be actuated for creating a closed or open circuit. The pre-sent solution is not limited in this regard.

In some examples, tag 200 includes an RFID subsystem, such as communication-enabled device 206 described above, operative to receive an RFID interrogation signal and respond with an RFID response. Such tags 200 include a non-RFID RF subsystem, also incorporated into device 204, operative to receive a non-RFID RF signal and respond by wirelessly indicating that the non-RFID subsystem received the non-RFID RF signal. In some such examples, the non-RFID subsystem responds that the non-RFID RF subsystem received the non-RFID RF signal by one of: allowing the RFID subsystem to respond to the RFID interrogation signal with an RFID response only upon the non-RFID RF subsystem having received a non-RFID RF signal concurrently: supplementing the RFID response with at least one information element indicating that the non-RFID RF subsystem received the non-RFID RF signal; and separately transmitting a non-RFID response. In some such examples, the non-RFID RF subsystem is a personal area network (PAN) signal. In some such examples, the PAN is a Bluetooth PAN.

In some examples of the technology disclosed herein, tag 200 is a piezoelectric-based tag 200′ including at least an EAS component 244 comprising a first piezoelectric element 244′, device 204′ (optionally including communication device 206), and a power source 236′. First piezoelectric element 244′ can be a piezoelectric transmitter. Piezoelectric transmitters can convert electrical signals into ultrasound energy. In such tags, the processing device is operative under certain conditions to use power from the power source to generate a signal causing the at least one piezoelectric element to emit ultrasound energy in a pattern based on the signal. In some examples, the certain conditions comprise one or more of movement of the article and accumulation of charge sufficient to power the processing device and the at least one piezoelectric EAS element.

Tag 200′ can be integrated into the article to be surveilled, e.g., object 110 and object 116, such that tag 200′ is generally, but not necessarily, hidden. For example, tag 200′ can be integrated into the fabric of an article of clothing, or integrated into or attached to the exterior of the article or its packaging. For example, tag 200 can be woven into the fabric of an article of clothing.

Power source 236′ can be one or more of several power sources including one or more of a second piezoelectric element, or a charge storage device such as a battery or capacitor. Using a second piezoelectric element as part of power source 236′ can take advantage of the ability of piezoelectric element to convert mechanical energy (e.g., stress/movement) into electrical energy. Thus tag 200′ can generate electrical power when the article the tag 200′ is embedded in is moved, stretched, jostled, or otherwise sufficiently disturbed. In this way a second piezoelectric element as a power source 236′ can also function as a motion sensor 250.—good!

Like other elements of tag 200′, power source 236′ can be integrated into the article to be surveilled, e.g., object 110, such that power source 236′ is generally, but not necessarily, hidden. Power source 236′ also can be securely attached to the article in a fashion that the power source 236′ can be removed with equipment generally available only to the RSF or under control/with electronic authorization of the retailer, e.g., to disable the alarm function of tag 200′ upon sale of the article. Power source 236′ can be charged and controlled using energy harvesting circuit 232 and power management circuit 234 as described elsewhere herein.

Device 204′ can convert this energy into an input signal for first piezoelectric element 244′ to emit an ultrasound signal. The input signal can encode information, such as item level information 134 and tag/article status—for example, by modulating the input signal to cause the first piezoelectric element 244′ to output an ultrasound signal modulated with such information.

In some examples, multiple first piezoelectric elements 244′ can be embedded in an article to provide multiplexing/diversity (e.g., frequency) that can allow carrying more information. For example, an 8-piezo article that can transmit X serial bits in a cycle can accommodate a large amount of information.

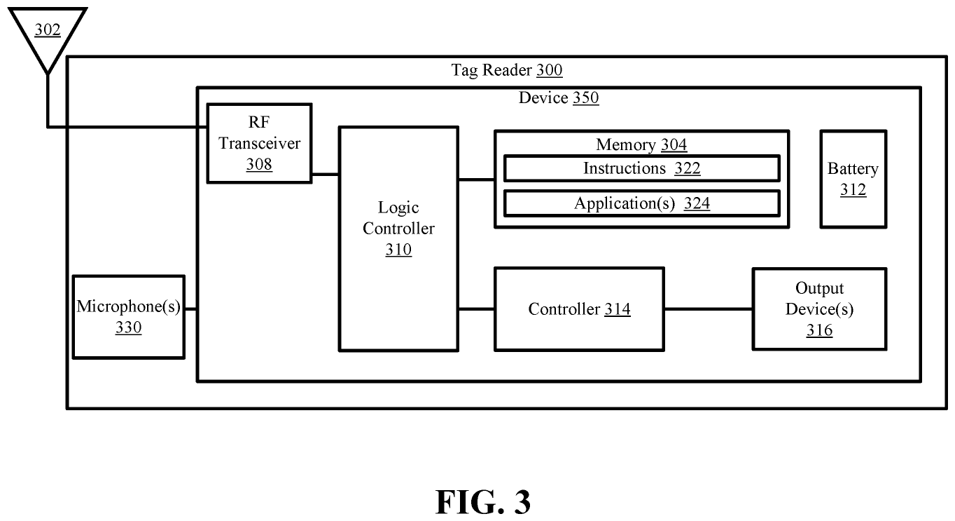

Referring now to FIG. 3, there is provided a detailed block diagram of an exemplary architecture for a tag reader 300. Tag reader 120 of FIG. 1 is the same as or similar to tag reader 300. As such, the discussion of tag reader 300 is sufficient for understanding tag reader 120.

Tag reader 300 may include more or less components than that shown in FIG. 3. However, the components shown are sufficient to disclose an illustrative embodiment implementing the present solution. Some or all of the components of the tag reader 300 can be implemented in hardware, software and/or a combination of hardware and software. The hardware includes, but is not limited to, one or more electronic circuits. The electronic circuit may comprise passive components (e.g., capacitors and resistors) and active components (e.g., processors) arranged and/or programmed to implement the methods disclosed herein.

The hardware architecture of FIG. 3 represents an illustration of a representative tag reader 300 configured to facilitate improved inventory counts and management within an RSF (e.g., RSF 128 of FIG. 1). In this regard, the tag reader 300 comprises a device 350 for allowing data to be exchanged with an external device (e.g., tags 112₁, . . . , 112_{N}, 118₁, . . . , 118_{X} of FIG. 1). The components 304-316 shown in FIG. 3 may be collectively referred to herein as the device 350, and may include a power source 312 (e.g., a battery) or be connected to an external power source (e.g., an AC mains).

The tag reader 300 can include an antenna 302 for allowing data to be exchanged with the external device via RF technology (e.g., RFID technology or other RF based technology). In some examples, the antenna 302 is configured to transmit RF carrier signals (e.g., interrogation signals) to the listed external devices, and/or transmit data response signals (e.g., authentication reply signals or an RFID response signal) generated by the Device 350. In this regard, the Device 350 comprises an RF transceiver 308. RF transceivers are well known in the art, and therefore will not be described herein. However, it should be understood that the RF transceiver 308 receives RF signals including information from the transmitting device, and forwards the same to a logic controller 310 for extracting the information therefrom.

The tag reader 300 can include one or more microphones 330 for allowing the tag reader 300 to listen for audio (e.g., ultrasonic audio) emitted from the external device (e.g., tag 200′). Microphone 330 can be directional, facilitating location determinations for tags 200′. A typical placement for at least one microphone is downward-facing overhead at an entrance/exit of an RSF 128. One or more directional microphones can be focused on various zones inside the RSF 128, including the near inside portion of the entrance/exits. One or more directional microphones can be focused on various zones outside the RSF 128, including the near outside portion of the RSF 128.

The extracted information can be used to determine the presence, location, and/or type of movement of an tag within a facility (e.g., RSF 128 of FIG. 1). Accordingly, the logic controller 310 can store the extracted information in memory 304, and execute algorithms using the extracted information. For example, the logic controller 310 can correlate tag reads with beacon reads to determine the location of the tags within the facility. For example, the logic controller 310 can correlate tag reads from different microphones to determine the location of the tags within the facility. The logic controller 310 can also perform pattern recognition operations using data received from tags and comparison operations between recognized patterns and pre-stored patterns. The logic controller 310 can further select a time slot from a plurality of time slots based on a tag's unique identifier (e.g., an EPC), and communicate information specifying the selected time slot to the respective tag. The logic controller 310 may additionally determine a WOT during which a given tag's communication device (e.g., transceiver) or operation(s) is (are) to be turned on when motion is detected thereby, and communicate the same to the given tag. The WOT can be determined based on environmental conditions (e.g., temperature, time of day, etc.) and/or system conditions (e.g., amount of traffic, interference occurrences, etc.). Other operations performed by the logic controller 310 will be apparent from the following discussion.

Notably, memory 304 may be a volatile memory and/or a non-volatile memory. For example, the memory 304 can include, but is not limited to, a RAM, a DRAM, an SRAM, a ROM, and a flash memory. The memory 304 may also comprise unsecure memory and/or secure memory. The phrase “unsecure memory,” as used herein, refers to memory configured to store data in a plain text form. The phrase “secure memory,” as used herein, refers to memory configured to store data in an encrypted form and/or memory having or being disposed in a secure or tamper-proof enclosure.

Instructions 322 are stored in memory for execution by the device 350 and that cause the reader 300 to perform any one or more of the methodologies of the present disclosure. The instructions 322 are generally operative to facilitate determinations as to whether or not tags are present within a facility, where the tags are located within a facility, which tags are in motion at any given time, and which tags are also in zone of a second RF signal (e.g., a Bluetooth beacon or NFC or other SRC system). Other functions of the device 350 will become apparent as the discussion progresses.

Referring now to FIG. 4, there is provided a detailed block diagram of an exemplary architecture for a server 400. Server 124 of FIG. 1 is the same as or substantially similar to server 400. As such, the following discussion of server 400 is sufficient for understanding server 124.

Notably, the server 400 may include more or less components than those shown in FIG. 4. However, the components shown are sufficient to disclose an illustrative embodiment implementing the present solution. The hardware architecture of FIG. 4 represents one embodiment of a representative server configured to facilitate inventory counts, inventory management, and improved customer experiences. As such, the server 400 of FIG. 4 implements at least a portion of some methods for EAS.

Some or all the components of the server 400 can be implemented as hardware, software and/or a combination of hardware and software. The hardware includes, but is not limited to, one or more electronic circuits. The electronic circuits can include, but are not limited to, passive components (e.g., resistors and capacitors) and/or active components (e.g., amplifiers and/or microprocessors). The passive and/or active components can be adapted to, arranged to, and/or programmed to perform one or more of the methodologies, procedures, or functions described herein.

As shown in FIG. 4, the server 400 comprises a user interface 402, a CPU 406, a system bus 410, a memory 412 connected to and accessible by other portions of server 400 through system bus 410, and hardware entities 414 connected to system bus 410. The user interface can include input devices (e.g., a keypad 450) and output devices (e.g., speaker 452, a display 454, and/or light emitting diodes 456), which facilitate user-software interactions for controlling operations of the server 400.

At least some of the hardware entities 414 perform actions involving access to and use of memory 412, which can be a RAM, a disk driver, and/or a Compact Disc Read Only Memory (“CD-ROM”). Hardware entities 414 can include a disk drive unit 416 comprising a computer-readable storage medium 418 on which is stored one or more sets of instructions 420 (e.g., software code) configured to implement one or more of the methodologies, procedures, or functions described herein. The instructions 420 can also reside, completely or at least partially, with-in the memory 412 and/or within the CPU 406 during execution thereof by the server 400. The memory 412 and the CPU 406 also can constitute machine-readable media. The term “machine-readable media,” as used here, refers to a single medium or multiple media (e.g., a centralized or distributed database, and/or associated caches and servers) that store the one or more sets of instructions 420. The term “machine-readable media,” as used here, also refers to any medium that is capable of storing, encoding, or carrying a set of instructions 420 for execution by the server 400 and that cause the server 400 to perform any one or more of the methodologies of the present disclosure.

In some scenarios, the hardware entities 414 include an electronic circuit (e.g., a processor) programmed for facilitating the provision of a three-dimensional map showing locations of tags within a facility and/or changes to said locations in near real-time. In this regard, it should be understood that the electronic circuit can access and run a software application 422 installed on the server 400. The software application 422 is generally operative to facilitate: the determination of tag locations within a facility: the direction of travel of tags in motion; and the mapping of the tag locations and movements in a virtual three-dimensional space.

In those or other scenarios, the hardware entities 414 include an electronic circuit (e.g., a processor) programmed for facilitating item inventorying, merchandise sale, and/or customer satisfaction with a shopping experience. In this regard, the electronic circuit can access and run an inventorying software application 422 and an MCD display software application 422 installed on the server 400. The software applications 422 are collectively generally operative to: obtain item level information and/or other information from MCDs and tags: program item level information, accessory information, related product information and/or discount information onto tags and/or MCDs: convert the language, pricing and/or currency symbol of item level information, accessory information, related product information and/or discount information: facilitate registration of tags and MCDs with an enterprise system; and/or determine when MCD display update actions need to be taken based on tag information. Other functions of the software applications 422 will become apparent as the discussion progresses. Such other functions can relate to tag reader control and/or tag control.

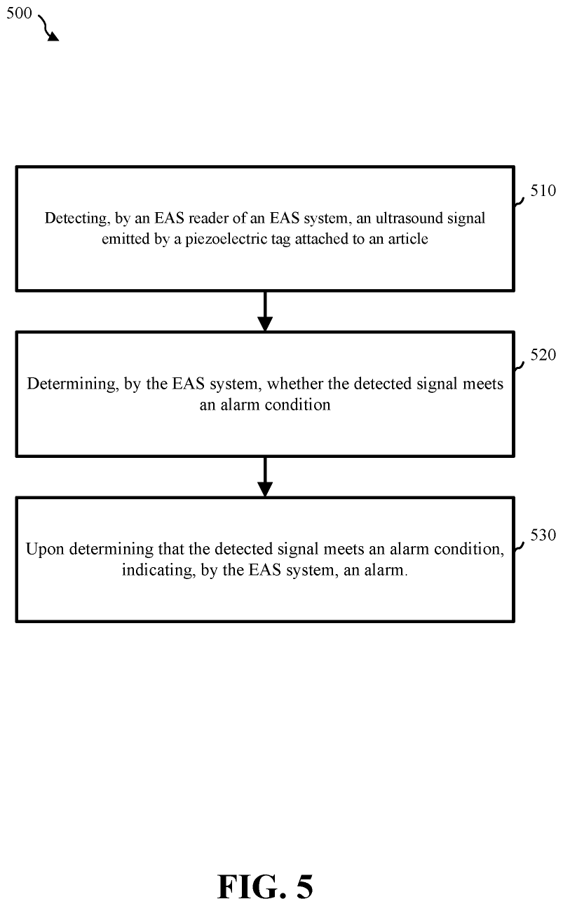

Referring to FIG. 5, methods 500 for electronic article surveillance are illustrated. In such methods, an EAS reader of an EAS system detects an ultrasound signal emitted by a piezoelectric tag attached to an article being surveilled—Block 510. Consider, as a continuing example, an EAS reader 300 with two directional ultrasonic microphones 330 providing means for executing the method. A first microphone 330 is deployed in the ceiling over an exit of a store 128 and can detect an ultrasound signal within a first area inside the store 128 that must be traversed to exit the store. A second microphone 330 is deployed in the ceiling to cover a second area that must be traversed to enter the first area. In other examples, more microphones, some with overlapping areas of ultrasound reception, can be used.

A piezoelectric tag such as tag 200′ is attached to each of a pair of sneakers. A person tries on the sneakers, and without purchasing the sneakers, walks into the second area. Walking in the sneakers creates sufficient force on a second piezoelectric element of the tag 200′ to create a voltage to charge an energy storage device of the tag 200′. Sufficiently charging energy storage device activates a processing device 204 configured as a circuit create a signal modulated with an identifier of the tag 200′. The tag 200′ applies the signal to a first piezoelectric element 244′ of the tag 200′, which broadcasts ultrasonic energy in accordance with the signal as modulated by the data describing the identifier of the tag 200′. Reader 300 detects ultrasonic energy and demodulates the signal to extract the tag 200′ identifier. At least the first piezoelectric element 244′ of the tag 200′ is embedded in the sole of the sneaker such that stepping creates sufficient force to charge the energy storage device. In some examples, such as this continuing example, the tag 200 can estimate the strength of the applied force from the characteristics of the charge.

The EAS system determines whether the detected signal meets an alarm condition-Block 520. In the continuing example, EAS server 400 determines that the article to which the tag 200′ is attached has not been purchased, and that based on the estimated strength of the applied force, the sneaker is not merely being carried, but is likely being walked in. In some examples, other characteristics, e.g., amplitude, phase, phase shift, and characteristics over time can be used to determine whether the signal meets an alarm condition. In the continuing example, a signal indicating that the person is walking (as opposed to carrying) and is only in the second area (and not in the first area) leads to the determination that an alarm condition does not exist.

However, after moving about in the second area, the person walks into the first area. At this time, the EAS reader, using the first microphone 330, not only detects an ultrasound signal emitted by the piezoelectric tag 200′ embedded in the sole of the sneaker, but determines that the sneaker are still not purchased (e.g., by consulting POS data stored in the server 400), that the person is walking at a faster pace, and has entered the area adjacent to the exit—an alarm condition.

The EAS system, upon determining that the detected signal meets an alarm condition, indicates an alarm-Block 530. In the continuing example, the alarm is a silent alarm alerting a security guard with an MCD 130 that the article corresponding to the tag 200′ identifier (as stored in a datastore of the server 400) is being removed from the store without authorization. Other types of alarms, recipients of the alarm, and actions consequent to the alarm as described elsewhere herein can be included.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims.

Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. An article, comprising:
an article body; and
an electronic article surveillance (EAS) tag attached to the article body, where the tag comprises:
a power source;
a processing device in electrical communication with the a power source; and
at least one piezoelectric element in electrical communication with the processing device,
wherein the processing device is operative under certain conditions to use power from the power source to generate a signal causing the at least one piezoelectric element to emit ultrasound energy in a pattern based on the signal.

2. The article of claim 1, wherein the EAS tag is integral to the article body.

3. The article of claim 1, wherein the EAS tag further comprises an energy harvesting circuit in communication with the a power source.

4. The article of claim 3, wherein:
the energy harvesting circuit comprises a second piezoelectric element operative to output electrical energy upon an application of force to the second piezoelectric element;
the power source comprises an energy storage device; and
the EAS tag is operative, upon an application of force to the second piezoelectric element, to charge the energy storage device.

5. The article of claim 1, wherein the processing device is operative to modulate the signal with information.

6. The article of claim 1, wherein the certain conditions comprise one or more of movement of the article and accumulation of charge sufficient to power the processing device and the at least one piezoelectric EAS element.

7. An electronic article surveillance (EAS) tag, comprising:
a power source;
a processing device in electrical communication with the power source; and
at least one piezoelectric element in electrical communication with the processing device,
wherein the processing device is operative under certain conditions to use power from the power source to generate a signal causing the at least one piezoelectric element to emit ultrasound energy in a pattern based on the signal.

8. The tag of claim 7, wherein the EAS tag is integral to an article body.

9. The tag of claim 7, wherein the EAS tag further comprises an energy harvesting circuit in communication with the power source.

10. The tag of claim 9, wherein:
the energy harvesting circuit comprises a second piezoelectric element operative to output electrical energy upon an application of force to the second piezoelectric element;
the power source comprises an energy storage device; and
the EAS tag is operative, upon an application of force to the second piezoelectric element to charge the energy storage device.

11. The tag of claim 7, wherein the processing device is operative to modulate the signal with information.

12. The tag of claim 7, wherein the certain conditions comprise one or more of movement of the tag and accumulation of charge sufficient to power the processing device and the at least one piezoelectric EAS element.

13. A method of electronic article surveillance (EAS), comprising:
detecting, by an EAS reader of an EAS system, an ultrasound signal emitted by a piezoelectric tag attached to an article;
determining, by the EAS system, whether the detected signal meets an alarm condition; and
upon determining that the detected signal meets an alarm condition, indicating, by the EAS system, an alarm.

14. The method of claim 13, wherein detecting comprises detecting via one or more of a plurality of microphones of the EAS system.

15. The method of claim 13, wherein determining comprises determining based on one or more of an amplitude, phase, frequency, and data content of the detected ultrasound signal.

16. The method of claim 13, wherein the piezoelectric tag comprises:
a power source;
a processing device in electrical communication with the power source; and
at least one piezoelectric element in electrical communication with the processing device,
wherein the processing device is operative under certain conditions to use power from the power source to generate a signal causing the at least one piezoelectric element to emit ultrasound energy in a pattern based on the signal.

17. The method of claim 16, wherein the EAS tag is integral to an article body.

18. The method of claim 16, wherein the EAS tag further comprises an energy harvesting circuit in communication with the power source.

19. The method of claim 18, wherein:
the energy harvesting circuit comprises a second piezoelectric element operative to output electrical energy upon an application of force to the second piezoelectric element;
the power source comprises an energy storage device; and
the EAS tag is operative, upon an application of force to the second piezoelectric element to charge the energy storage device.

20. The method of claim 16, wherein the processing device is operative to modulate the signal with information.

21. The method of claim 16, wherein the certain conditions comprise one or more of movement of the tag and accumulation of charge sufficient to power the processing device and the at least one piezoelectric element.

22. A method for operating an electronic article surveillance (EAS) tag, comprising:
providing an article as described in claim 1; and
upon one or more of movement of the article and accumulation of charge sufficient to power the processing device and the at least one piezoelectric EAS element:
generating, by the processing device, a signal causing the at least one piezoelectric element to emit ultrasound energy in a pattern based on the signal; and
emitting, by the at least one piezoelectric element in response to the generating, ultrasound energy in a pattern based on the signal.

23. A non-transitory computer-readable medium comprising instructions that when executed by one or more computing devices are operative to perform the method of claim 22.
